(19) United States
(12) Patent Application Publication
(10) Pub. No.: US 2004/0144330 A1
(43) Pub. Date: Jul. 29, 2004

(54) Waste-reducing food dispenser, particularly for cages for small animals

(75) Inventor: Domenico Marchioro, Frazione Castelnovo (IT)

Correspondence Address: MODIANO & ASSOCIATI, Via Meravigli, 16, MILANO, 20123, IT

(73) Assignee: MARCHIORO S.P.A. STAMPAGGIO MATERIE PLASTICHE

(21) Appl. No.: 10/756,326

(22) Filed: Jan. 14, 2004

(30) Foreign Application Priority Data
Jan. 16, 2003 (IT) PD2003A000006

(51) Int. Cl. A01K 39/01; A01K 7/00; A01K 5/00

(52) U.S. Cl. 119/477

(57) ABSTRACT

A waste-reducing food dispenser particularly for cages for small animals, comprising a box-like body, with an opening at which elements for fixing to the cage are provided, and an internal food-carrying tray, the food dispenser having at least one portion of the base of the box-like body that is grille-like. A recovery tray is coupled, by way of removable couplings, on the box-like body and below the base, the dimensions of the recovery tray being sufficient to cover at least the grille-like portion of the base. The box-like body comprises elements for insertion/extraction of the food-carrying tray.

### BACKGROUND OF THE INVENTION

The present invention relates to a waste-reducing food dispenser, particularly for cages for small animals.

Food dispensers that can be applied to cages, comprising a tray for food, accessed by small animals, such as for example canaries, directly from the cage in order to obtain food, are currently known.

This direct access of the small animals to said food-carrying tray is due to the fact that known food dispensers are structured so that said tray is arranged adjacent to the walls of the cage.

Moreover, said food dispensers have a rod-like supporting element for the small animals, which is associated with the tray so that said small animals can reach the food comfortably.

Food is replaced in said food-supporting trays substantially according to two methods.

A first method entails disengaging the entire food dispenser from the cage.

In a second method, top-up is performed through a flap that can be opened upward and is rigidly coupled to the food dispenser and to the tray, accordingly avoiding the disengagement of the food dispenser from the cage.

These food dispensers have a vast market in view of their constructive simplicity and their low cost.

Said food dispensers as described above, although known and commercially appreciated for several years, suffer from drawbacks.

A first drawback is that the food removed and not ingested by the animal that uses the dispenser is generally released inside the cage, mixing with the dirt that is present on the bottom of the cage.

In this manner, the food that has not been ingested cannot be recovered and indeed contributes to increase said dirt.

A second drawback is due to the fact that it is difficult to refill said food-carrying tray, either because it is necessary to remove the entire food dispenser from the cage or because refilling through the upward-opening flap is not handy to perform.

### SUMMARY OF THE INVENTION

The aim of the present invention is to provide a waste-reducing food dispenser that allows to recover the food that is not ingested by the animals.

Within this aim, an object of the present invention is to provide a waste-reducing food dispenser that has a food-carrying tray that is easy to access and convenient to refill.

Another object of the present invention is to provide a waste-reducing food dispenser that has low constructive complexity and low production costs.

Another object of the present invention is to provide a waste-reducing food dispenser that is easy to maintain.

Another object of the present invention is to provide a waste-reducing food dispenser that can be manufactured with known technologies.

This aim and these and other objects that will become better apparent hereinafter are achieved by a waste-reducing food dispenser particularly for cages for small animals, which comprises a box-like body, provided with an opening at which means for fixing to the cage are provided, and an internal food-carrying tray, said food dispenser being characterized in that at least one portion of the base of said box-like body is grille-like, said at least one portion of the base not being arranged below said food-carrying tray, a recovery tray being coupled, by way of removable coupling means, on said box-like body and below said base, the dimensions of said recovery tray being sufficient to cover at least said grille-like portion of the base.

Advantageously, said waste-reducing food dispenser is characterized in that said box-like body comprises elements for extracting/inserting said food carrying tray.

### BRIEF DESCRIPTION OF THE DRAWINGS

Further characteristics and advantages of the present invention will become better apparent from the following detailed description of an embodiment thereof, illustrated by way of non-limiting example in the accompanying drawings, wherein:

FIG. 1 is a perspective view of the food dispenser according to the invention, associated with the appropriately provided opening of a cage;

FIG. 2 is a front perspective view of the food dispenser according to the invention, shown separately;

FIG. 3 is a perspective view of the food dispenser according to the invention, shown exploded into its main components;

FIG. 4 is a bottom perspective view of a portion of the food dispenser.

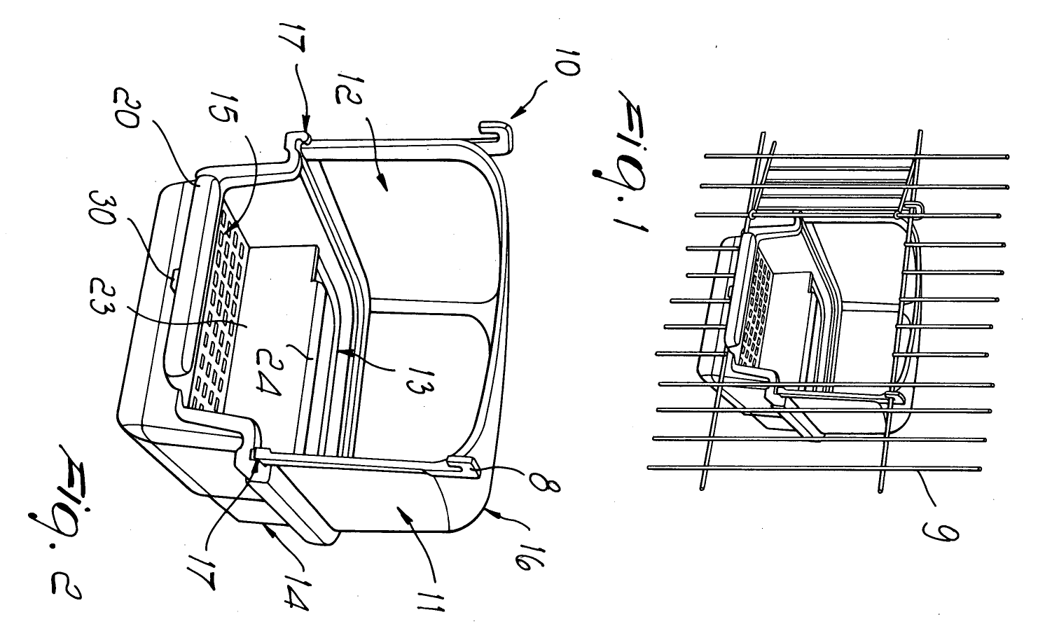

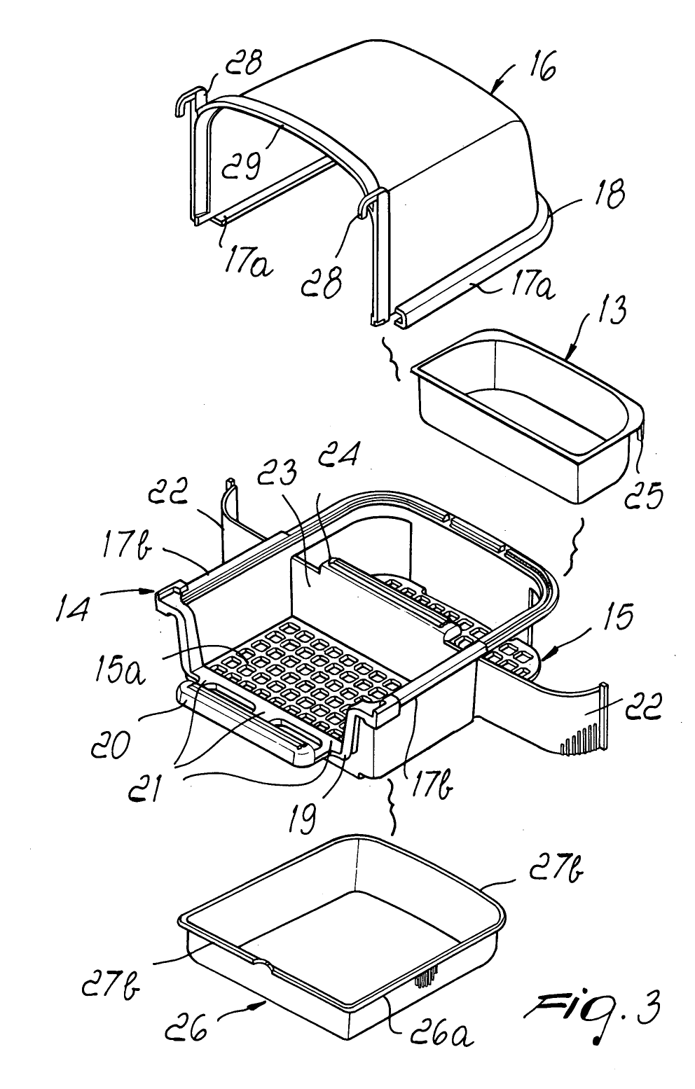

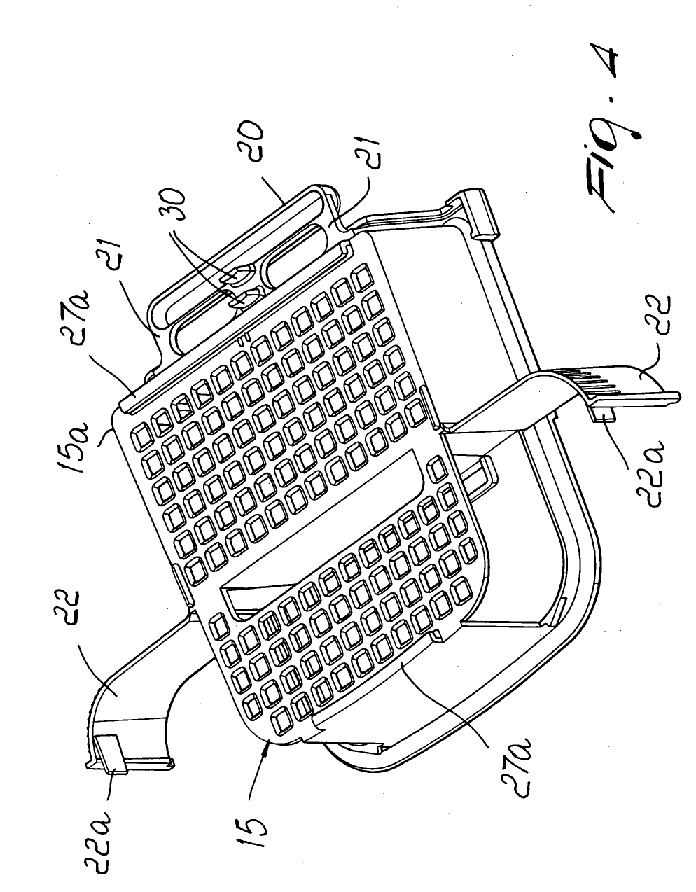

### DESCRIPTION OF THE PREFERRED EMBODIMENTS

With reference to the figures, a waste-reducing food dispenser is generally designated by the reference numeral 10.

The waste-reducing food dispenser 10 comprises a box-like body 11, with an opening 12 at which fixing means 8 for fixing to the cage 9 are provided, and an internal food-carrying tray 13.

The box-like body 11 is composed of a central tray 14 with a grille-like base 15 and a cover 16, said base and said cover being joined by way of removable connecting means 17.

Such removable connecting means 17 are constituted by a first pair of mutually opposite guides 17a that have a C-shaped cross-section and are arranged on lateral perimetric portions of a lower rim 18 of the cover 16, and by corresponding upper rims 17b of the central tray 14, whose cross-section is complementary to the cross-section of the guides 17a.

The central tray 14 monolithically comprises, in addition to the already mentioned upper rims 17b and the grille-like base 15, on its front edge 19, a first rod-like element 20 that acts as a perch and is parallel to the front edge 19.

The first rod-like element 20 has a substantially trapezoidal cross-section and a grooved surface.

The first rod-like element 20 is associated with said front edge by means of bridge elements 21, which are also monolithic with the tray 14.

The central tray 14 further comprises two access elements for insertion/extraction with respect to the food-carrying tray 13, which are constituted by two rear lateral flaps or doors 22 provided with removable locking means.

Such removable locking means are constituted by two teeth 22a for engaging the tray 13, one for each flap or door 22.

Moreover, the central tray 14 is crossed from one side to the other by a transverse wall 23 proximate to the articulations of the rear lateral flaps 22.

The wall 23 has, on its upper edge, a second rod-like element 24 that acts as a perch and also has a substantially trapezoidal cross-section and a grooved surface.

The doors 22, the respective engagement teeth 22a, the second rod-like element 24 and the transverse wall 23 are monolithic with the central tray 14.

The wall 23 delimits a front portion 15a of the grille-like base 15 that is arranged offset with respect to the food carrying tray 13, adjacent to the opening 12 and forms, together with the wall of the tray 14 that lies opposite the opening 12 and together with the flaps 22, the back region where the food-carrying tray 13 is located.

Such food-carrying tray 13 comprises two grip elements for extracting it, which are constituted by two tooth-like protrusions 25 that are directed downward and are arranged angularly on the upper rim of the food-carrying tray 13.

A lower recovery tray 26 is rigidly coupled to the box-like body 11 and therefore in a lower region with respect to the base 15 of the tray 14, by way of removable coupling means 27 described in greater detail hereinafter.

The perimeter of the upper rim 26a of the recovery tray 26 mates with the perimeter of the lower rim of the box-like body 11 and therefore with the perimeter of the grille-like base 15 of the central tray 14.

The removable coupling means 27 are constituted by a second pair of mutually opposite guides 27a that have a C-shaped cross-section and are arranged on two perimetric parts of the lower face of the grille-like base 15.

The first of said perimetric parts is adjacent to the bridge elements 21 and the second perimetric part lies on the opposite side.

Moreover, the removable coupling means 27 are constituted by corresponding portions 27b of the upper rim 26a of the lower tray 26.

The portions 27b have a cross-section that is shaped complementarily to the cross-section of the guides 27a.

The means 8 for fixing the box-like body 11 to the cage 9 are constituted by first and second removable engagement means, respectively on the cover 13 and on the central tray 14.

The first removable engagement means are constituted by two lateral protrusions 28 that are shaped like a hook that is directed downward on the front edge 29 of the cover 16.

The second removable engagement means are constituted by a clamp-like connection 30 that is directed downward and is arranged below the central element of the bridge elements 21.

In practice it has been found that the invention thus described solves the problems noted in known types of food dispenser for cages for small animals.

In particular, the present invention provides a waste-reducing food dispenser in which the food that is not ingested by the small animals does not fall onto the bottom of the cage but collects, through the grille-like base 15, in the lower recovery tray 26.

The tray 26 can be extracted and therefore allows to recover the food that would otherwise be lost on the bottom of the cage.

Moreover, it is noted that the waste-reducing food dispenser according to the invention allows, through the flaps or doors 22, to extract/insert the food-carrying tray 13, making it easy to perform food refilling/replacement.

The invention thus conceived is susceptible of modifications and variations, all of which are within the scope of the appended claims; all the details may further be replaced with other technically equivalent elements.

In practice, the materials employed, so long as they are compatible with the specific use, as well as the dimensions, may be any according to requirements and to the state of the art.

The disclosures in Italian Patent Application No. PD2003A000006 from which this application claims priority are incorporated herein by reference.

What is claimed is:

1. A waste-reducing food dispenser for cages for small animals, comprising: a box-shaped body provided with an opening; fixing means for fixing the body to a cage; an internal back food-carrying tray; a base of said body, having at least one front portion that is shaped as a grille, and is arranged offset with respect to said food-carrying tray; a lower recovery tray provided with removable coupling means for coupling thereof to said box-like body and below said base, said recovery tray having a size sufficient to cover at least said grille-shaped portion of said base.

2. The waste-reducing food dispenser of claim 1, wherein said at least one grille-shaped portion of the base is shaped so as to extend along an entire surface region of said base.

3. The waste-reducing food dispenser of claim 1, wherein said lower recovery tray has an upper rim with a perimeter region thereof that substantially mates with a perimeter region of a lower rim of the box-shaped body.

4. The waste-reducing food dispenser of claim 1, wherein said removable coupling means are constituted by two mutually opposite guides that have a C cross-sectional shape and are arranged on front and rear perimetric parts of a lower face of said box-shaped body and in corresponding portions of an upper edge of said recovery tray, said corresponding portions of the recovery tray having a cross-section shape that is complementary to the cross-sectional shape of said guides.

5. The waste-reducing food dispenser of claim 1, wherein said box-shaped body is composed of a central tray with a grille-shaped base and a cover that is connected to said central tray by way of removable connecting means.

6. The waste-reducing food dispenser of claim 5, wherein said central tray and said grille-shaped base are provided as a monolithic structure.

7. The waste-reducing food dispenser of claim 5, wherein said removable connecting means are constituted by two guides that are mutually opposite and have a C cross-sectional shape on lateral perimetric portions of a lower rim of said cover, and by corresponding upper rims of said central tray, said upper rims having a shape complementary to the cross-sectional shape of said two guides.

8. The waste-reducing food dispenser of claim 1, wherein said fixing means for fixing to the cage are constituted by first and second removable engagement means, respectively arranged on said cover and on said central tray.

9. The waste-reducing food dispenser of claim 8, wherein said first removable engagement means are constituted by two lateral protrusions that are hook-shaped and arranged directed downward onto a front rim of said cover.

10. The waste-reducing food dispenser of claim 8, wherein said second removable engagement means are constituted by a clamp-like connection that is arranged directed downward at, and proximate to, a lower rim of said opening.

11. A waste-reducing food dispenser for cages for small animals, comprising a box-shaped body, provided with an opening at which the fixing means for fixing to the cage are provided, and an internal food-carrying tray, said box-shaped body comprising access elements for inserting/extracting said food-carrying tray.

12. The waste-reducing food dispenser of claim 11, wherein said food-carrying tray is arranged opposite with respect to said opening inside said box-shaped body.

13. The waste-reducing food dispenser of claim 11, wherein said access elements are constituted by two rear lateral flaps provided with removable locking means for locking thereof in closed arrangement.

14. The waste-reducing food dispenser of claim 13, wherein said removable locking means are constituted by two teeth for engaging the central tray, one tooth for each one of the rear lateral flaps.

15. The waste-reducing food dispenser of claim 11, wherein said food-carrying tray comprises at least one grip element for extraction.

16. The waste-reducing food dispenser of claim 15, wherein said at least one grip element is constituted by two tooth-like protrusions that are directed downward and are arranged angularly on an upper rim region of said food-carrying tray.

17. A waste-reducing food dispenser for cages for small animals, comprising a box-shaped body with an opening; fixing means for fixing the body to a cage; a rear internal food-carrying tray; a base of said body having at least one front portion shaped as a grille, said at least one front portion being arranged offset with respect to said food-carrying tray; a recovery tray that is rigidly coupled by way of removable coupling means on said box-shaped body, below said base, said recovery tray being sized so as to cover at least said front portion of the bottom, said box-shaped body further comprising elements for insertion/extraction with respect to said food-carrying tray.

18. The waste-reducing food dispenser of claim 13, wherein said central tray comprises a transverse wall arranged proximate to articulation regions of said rear lateral flaps to said central tray.

19. The waste-reducing food dispenser of claim 18, wherein said transverse wall comprises a rod-like element located on an upper rim thereof.

20. The waste-reducing food dispenser of claim 19, wherein said rod-like element has a substantially trapezoidal cross-section and a grooved surface.

21. The waste-reducing food dispenser of claim 19, wherein said rod-like element and said transverse wall are provided monolithic with said central tray.
